(19) United States
(12) Patent Application Publication
(10) Pub. No.: US 2014/0112157 A1
(43) Pub. Date: Apr. 24, 2014

(54) METHOD AND APPARATUS FOR SENDING PACKET, UPDATING AND MAINTAINING HYPER FRAME NUMBER, AND PROCESSING DATA

(71) Applicant: HUAWEI TECHNOLOGIES CO., LTD, Shenzhen (CN)

(72) Inventor: Guanglin HAN, Beijing (CN)

(73) Assignee: HUAWEI TECHNOLOGIES CO., LTD, Shenzhen (CN)

(21) Appl. No.: 14/142,029

(22) Filed: Dec. 27, 2013

Related U.S. Application Data
(63) Continuation of application No. PCT/CN2012/077621, filed on Jun. 27, 2012.

(30) Foreign Application Priority Data
Jun. 27, 2011 (CN) 201110175353.1

(51) Int. Cl. H04W 28/06; H04W 24/08

(52) U.S. Cl. CPC H04W 28/065; H04W 24/08
USPC 370/242; 370/328

(57) ABSTRACT

The present invention relates to the field of communications technologies, and discloses a method and an apparatus for sending a packet, updating and maintaining a PDCP layer hyper frame number state, and processing data. The method for processing data includes: according to a sequence number in a received packet, determining whether a service data unit in the packet needs to be read; if the service data unit in the packet does not need to be read, determining whether a header compression algorithm is configured for a current PDCP entity or a bearer link corresponding to the PDCP entity; and discarding the service data unit in the packet directly if a result of the judgment indicates that no header compression algorithm is configured for the packet or the current PDCP entity.

### CROSS REFERENCE

This application claims a continuation of International Application No. PCT/CN2012/077621, filed on Jun. 27, 2012, which claims priority to Chinese Patent Application No. 201110175353.1, filed on Jun. 27, 2011, both of which are hereby incorporated by reference in their entireties.

### TECHNICAL FIELD

The present invention relates to the field of communications technologies, and in particular, to a method and an apparatus for sending a packet, updating and maintaining a PDCP layer hyper frame number state, and processing data.

### BACKGROUND

In an existing LTE (Long Term Evolution, Long Term Evolution) system, to ensure that data transmitted over an air interface can be sequentially transferred to an application layer on the reception side, sequence numbers are allocated to packets on the transmission side. That is, at a PDCP (Packet Data Convergence Protocol, Packet Data Convergence Protocol) layer, a count value (Count) is allocated to a packet according to the order of the received packet. The count value includes two parts: a hyper frame number (HFN, Hyper Frame Number) and a sequence number (SN, Sequence Number). In the data transmission process, the sequence number SN in the count value Count and the data content are concurrently sent to the reception side; and an HFN state is separately maintained on the transmission side and the reception side. The HFN states need to keep synchronous between both sides.

Because only the SN is carried in the packet for transmission, the reception side has to, according to the received SN value, infer the HFN value used when the transmission side processes the packet, so as to update the HFN value on the reception side.

In addition, to ensure data confidentiality and integrity, the sent data content needs to be enciphered and/or integrity-protected at the PDCP layer. In the existing enciphering and integrity protection algorithms, a Count value needs to be used as an input parameter. The transmission side uses a Count value in the enciphering or integrity protection process, and correspondingly, the reception side uses the Count value in the deciphering and integrity verification process. To ensure successful receiving of a packet, the transmission side and the reception side need to use the same Count value for the same packet. Otherwise, the deciphering and/or integrity verification process fails, and the packet cannot be received correctly.

In the process of implementing the data transmission, the inventor finds at least the following problems in the prior art:

If an SN value in a packet is modified while being transmitted over an air interface and the reception side still considers that the SN value in the received packet is credible, the reception side updates a locally maintained HFN value according to the received SN value. As a result, the HFN value may be incorrectly updated and therefore the transmission side and the reception side use different Count values. Consequently, the subsequent packet deciphering and/or integrity verification cannot go on normally, and the packet cannot be received correctly, which wastes air interface resources and affects user experience.

In addition, if the PDCP layer of the reception side determines, according to the SN carried in a protocol data unit (Protocol Data Unit, PDU) packet header in the received packet, that the PDCP layer of the reception side does not need the service data unit (Service Data Unit, SDU) carried in the packet, but an ROHC (Robust Header Compression, robust header compression) entity at the PDCP layer requires header compression information carried in the PDU, and therefore, the reception side still needs to decipher (Deciphering) the PDU and deliver the deciphered data to the ROHC entity for processing, so as to obtain the header compression information and then discard the SDU obtained after the PDU is deciphered.

However, ROHC depends on optional functions configured by a base station; for a bearer (such as a link or channel) of a terminal, an ROHC algorithm is not necessarily configured, or the ROHC algorithm may be set to NULL indicating no use of header compression. In this scenario, the PDCP layer of the reception side still deciphers the PDU persistently, which increases processing overhead of the terminal.

### SUMMARY

In one aspect, an embodiment of the present invention provides a method and an apparatus for sending a packet, and updating and maintaining a PDCP layer hyper frame number state, to solve a problem that a PDCP layer hyper frame number is incorrectly updated on a data reception side.

To achieve this objective, the embodiment of the present invention adopts the following technical solutions:

A method for updating a PDCP layer hyper frame number state includes:

receiving a packet;

performing anti-tampering verification for a sequence number in the received packet; and

updating the hyper frame number state on the packet reception side according to the sequence number if a result of the verification indicates that the sequence number passes the anti-tampering verification.

A method for sending a packet includes:

performing anti-tampering protection for a sequence number in a header of a packet to be sent; and

encapsulating the packet and sending it to a reception side.

A method for maintaining a PDCP layer hyper frame number state includes:

updating a hyper frame number state according to a sequence number in a received packet;

when a packet error occurs subsequently, determining whether the hyper frame number has been modified; and

recovering the hyper frame number to a before-modification state if the hyper frame number has been modified.

An apparatus for updating a PDCP layer hyper frame number state includes:

a receiving unit, configured to receive a packet;

a verifying unit, configured to perform anti-tampering verification for a sequence number in the received packet; and

an updating unit, configured to update the hyper frame number state on the packet reception side according to the sequence number if a verification result generated by the verifying unit indicates that the sequence number passes the anti-tampering verification.

An apparatus for sending a packet includes:

a protecting unit, configured to perform anti-tampering protection for a sequence number in a header of a packet to be sent;

an encapsulating unit, configured to encapsulate the packet; and

a sending unit, configured to send the encapsulated packet to a reception side.

An apparatus for maintaining a PDCP layer hyper frame number state includes:

an updating unit, configured to update a hyper frame number state according to a sequence number in a received packet;

a determining unit, configured to: when a packet error occurs subsequently, determine whether the hyper frame number has been modified; and

a recovering unit, configured to recover the hyper frame number to a before-modification state if a judgment result generated by the determining unit indicates that the hyper frame number has been modified.

In the method and apparatus for sending a packet, and updating and maintaining a PDCP layer hyper frame number state according to the embodiment of the present invention, after a packet is received, a sequence number in the packet undergoes anti-tampering verification and then the hyper frame number state is updated, or the hyper frame number state is recovered if modification of the hyper frame number is determined after a packet error occurs when the reception side processes the received packet, which solves the problems in the prior art such as a failure to decipher the packet subsequently because the hyper frame number is incorrectly updated. Compared with the prior art, the solutions in the embodiment of the present invention can solve the problem that the hyper frame number corresponding to the PDCP layer packet is updated incorrectly, and ensure that subsequent processes such as packet deciphering and/or integrity verification can be normally performed, which improves the success rate and reliability of data transmission and enhances quality of service of a system.

In another aspect, an embodiment of the present invention further provides a method and an apparatus for processing PDCP layer data, to reduce processing overhead on a reception side.

To achieve this objective, the embodiment of the present invention adopts the following technical solutions:

A method for processing PDCP layer data includes:

determining, according to a sequence number in a received packet, whether a service data unit in the packet needs to be read;

determining, if the service data unit in the packet does not need to be read, whether a header compression algorithm is configured for a current PDCP entity or a bearer link corresponding to the PDCP entity; and

discarding the service data unit in the packet if a result of the judgment indicates that no header compression algorithm is configured for the packet or the current PDCP entity.

An apparatus for processing PDCP layer data includes:

a first determining unit, configured to: according to a sequence number in a received packet, determine whether a service data unit in the packet needs to be read;

a second determining unit, configured to: if an output result of the first determining unit indicates that the service data unit in the packet does not need to be read, determine whether a header compression algorithm is configured for a current PDCP entity or a bearer link corresponding to the PDCP entity; and

a first processing unit, configured to discard the service data unit in the packet if a judgment result generated by the second determining unit indicates that no header compression algorithm is configured for the packet or the current PDCP entity.

In the method and apparatus for processing PDCP layer data according to the embodiment of the present invention, when the reception side of a packet does not need a service data unit carried in the packet, before deciphering a protocol data unit PDU in the received packet, the reception side determines whether a header compression algorithm is configured for a PDCP entity or a bearer link corresponding to the PDCP entity, and, according to the judgment result, determines whether the PDU in the packet needs to be deciphered, so as to reduce unnecessary deciphering and decompression processing and reduce processing overhead on the reception side.

### BRIEF DESCRIPTION OF DRAWINGS

To describe the technical solution in the embodiments of the present invention more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a flowchart of a method for updating a PDCP layer hyper frame number state according to Embodiment 1 of the present invention;

FIG. 2 is a schematic structural diagram of an apparatus for updating a PDCP layer hyper frame number state according to Embodiment 1 of the present invention;

FIG. 3 is a flowchart of a method for sending a packet according to Embodiment 1 of the present invention;

FIG. 4 is a schematic structural diagram of an apparatus for sending a packet according to Embodiment 1 of the present invention;

FIG. 5 is a flowchart of a method for updating a hyper frame number state according to Embodiment 2 of the present invention;

FIG. 6 is a schematic structural diagram of an apparatus for updating a PDCP layer hyper frame number state according to Embodiment 2 of the present invention;

FIG. 7 is a schematic structural diagram of an apparatus for sending a packet according to Embodiment 2 of the present invention;

FIG. 8 is a flowchart of a method for maintaining a PDCP layer hyper frame number state according to Embodiment 3 of the present invention;

FIG. 9 is a schematic structural diagram of an apparatus for maintaining a PDCP layer hyper frame number state according to Embodiment 3 of the present invention;

FIG. 10 is a flowchart of a method for maintaining a hyper frame number state according to Embodiment 4 of the present invention;

FIG. 11 is a first schematic diagram of a hyper frame number HFN state according to Embodiment 4 of the present invention;

FIG. 12 is a second schematic diagram of a hyper frame number HFN state according to Embodiment 4 of the present invention;

FIG. 13 is a flowchart of a method for processing PDCP layer data according to Embodiment 5 of the present invention;

FIG. 14 is a schematic structural diagram of an apparatus for processing PDCP layer data according to Embodiment 5 of the present invention;

FIG. 15 is a flowchart of a method for processing PDCP layer data according to Embodiment 6 of the present invention;

FIG. 16 is a schematic diagram of a sequence number SN state according to Embodiment 6 of the present invention; and

FIG. 17 is a schematic structural diagram of an apparatus for processing PDCP layer data according to Embodiment 6 of the present invention.

### DESCRIPTION OF EMBODIMENTS

The following clearly and describes the technical solutions in the embodiments of the present invention with reference to the accompanying drawings in the embodiments of the present invention. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

### Embodiment 1

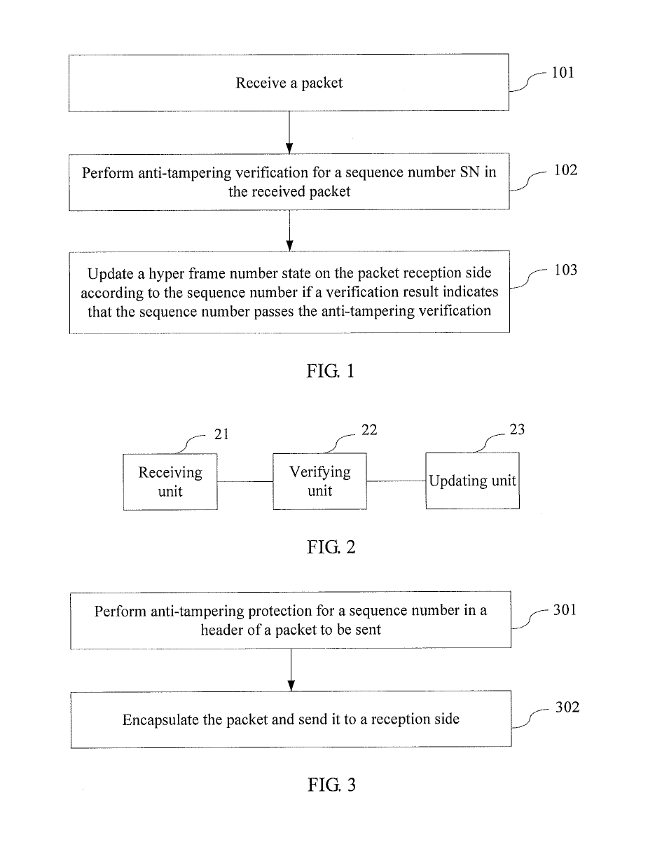

As shown in FIG. 1, a method for updating a PDCP layer hyper frame number state according to the embodiment of the present invention includes the following steps:

101. Receive a packet.

102. Perform anti-tampering verification for a sequence number SN in the received packet.

In this embodiment, the anti-tampering verification may be at least one of integrity verification and a CRC (Cyclic Redundancy Check, cyclic redundancy check).

103. Update the hyper frame number state on the packet reception side according to the sequence number if a result of the verification indicates that the sequence number passes the anti-tampering verification.

The foregoing steps are performed by a reception side of the packet, which may be a terminal side or a network side.

Corresponding to the method, the embodiment of the present invention further provides an apparatus for updating a hyper frame number state. As shown in FIG. 2, the apparatus includes:

a receiving unit 21, configured to receive a packet;

a verifying unit 22, configured to perform anti-tampering verification for a sequence number in the received packet; and

an updating unit 23, configured to update a hyper frame number state on the packet reception side according to the sequence number if a verification result generated by the verifying unit indicates that the sequence number passes the anti-tampering verification.

The method for updating a PDCP layer hyper frame number state is performed by a packet reception side. Correspondingly, the embodiment of the present invention further provides a method for sending a packet by a packet transmission side. As shown in FIG. 3, the method for sending a packet in the embodiment includes the following steps:

301. Perform anti-tampering protection for a sequence number in a header of a packet to be sent.

In this embodiment, the anti-tampering protection may be at least one of integrity protection and cyclic redundancy check (CRC) protection.

302. Encapsulate the packet and send it to a reception side.

The foregoing steps are performed by a transmission side of the packet, which may be a network side or a terminal side.

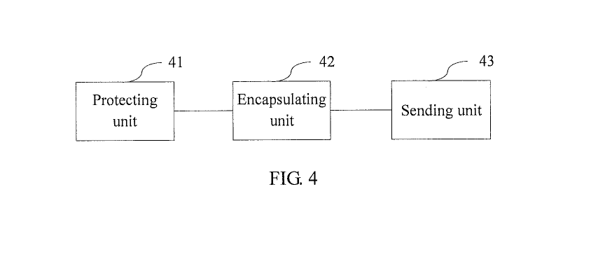

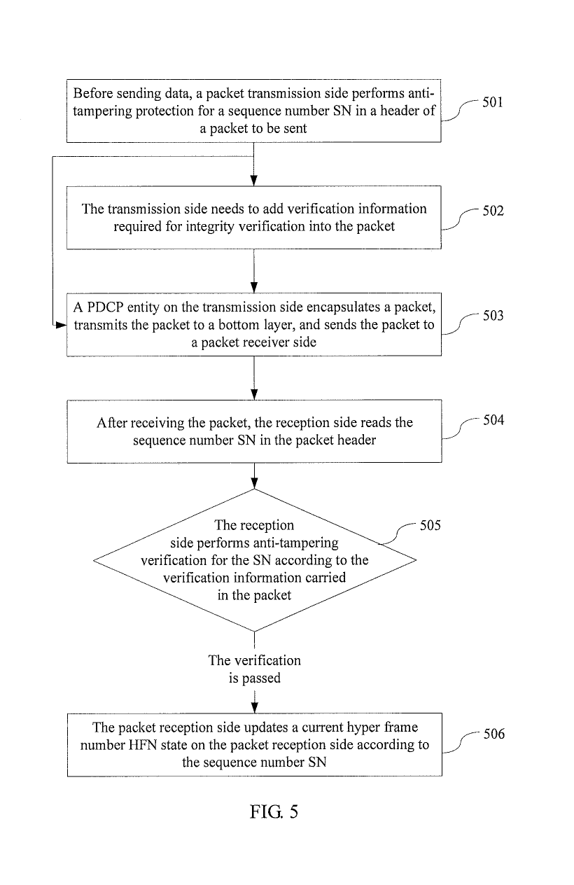

Corresponding to the method for sending a packet, this embodiment further provides an apparatus for sending a packet, which is used to implement the method for sending a packet. As shown in FIG. 4, the apparatus for sending a packet includes:

a protecting unit 41, configured to perform anti-tampering protection for a sequence number in a header of a packet to be sent;

an encapsulating unit 42, configured to encapsulate the packet; and

a sending unit 43, configured to send the encapsulated packet to a reception side.

In the method and apparatus for updating a PDCP layer hyper frame number state according to the embodiment of the present invention, after a packet is received, the sequence number SN in the packet undergoes anti-tampering verification, and the hyper frame number state on the packet reception side is not updated until the verification is passed, which solves the problems in the prior art such as a failure to decipher the packet subsequently because a hyper frame number is incorrectly updated. The foregoing solution can solve the problem that the hyper frame number corresponding to a PDCP layer packet is updated incorrectly, and ensure that subsequent processes such as packet deciphering and/or integrity verification can be normally performed, which improves the success rate and reliability of data transmission and enhances quality of service of a system.

### Embodiment 2

In this embodiment, a specific instance is used to further describe a method for updating a hyper frame number state according to the embodiment of the present invention.

As shown in FIG. 5, the method for updating a hyper frame number state in this embodiment specifically includes the following steps:

501. Before sending data, a packet transmission side performs anti-tampering protection for a sequence number SN in a header of a packet to be sent.

In this embodiment, manners of the anti-tampering protection for the SN include at least one of integrity protection and CRC (Cyclic Redundancy Check, cyclic redundancy check) protection. In the following description, integrity protection is used as an example to describe the method for maintaining a hyper frame number state in this embodiment.

A process of integrity protection for an SN is roughly as follows:

S1. A terminal and a network side perform a key negotiation process to determine a key for use in integrity protection and integrity verification.

S2. The network side configures an integrity protection algorithm for the terminal.

S3. A packet transmission side, which may be a network side or a terminal, uses the integrity protection algorithm and the integrity protection key to perform integrity protection for content to be protected, such as a sequence number SN.

Input parameters used in the integrity protection algorithm may include not only the current SN value, but may also include additional input parameters such as a count value Count and/or a data transmission direction. If more input parameters are used in the integrity protection algorithm, the integrity verification performed by the reception side for the SN in the packet is certainly more accurate.

In the subsequent integrity verification process, if the reception side needs to use part or all of results generated by the transmission side in the integrity protection, that is, encrypted bit (bit) strings that are obtained after the data undergoes integrity protection processing, the transmission side needs to add part or all of the results generated in the integrity protection process and intended for verification into the packet.

502. If the reception side needs to perform the integrity verification for the SN, the transmission side needs to add verification information required for the integrity verification into the packet.

The verification information includes at least all or part of information in a MAC-I (Message Authentication Code for Integrity, message authentication code for integrity). Specifically, the information required for integrity verification may be carried in a header part or a trailer part of the packet.

Step 502 may be skipped if the verification information is not required in the subsequent integrity verification.

503. A PDCP entity on the transmission side encapsulates a packet, transmits the packet to a bottom layer such as an RLC (Radio Link Control, radio link control) layer, and sends the packet to the packet reception side through the RLC layer.

504. After receiving the packet, the reception side reads the sequence number SN in the packet header.

505. If the packet carries the information required for the integrity verification, the reception side performs anti-tampering verification for the SN according to the verification information carried in the packet.

The anti-tampering verification includes at least one of integrity verification and a cyclic redundancy check. In this embodiment, integrity verification is used as an example, and therefore, in this step, the reception side performs the integrity verification for the SN according to the verification information carried in the packet.

If the packet carries no verification information, the terminal may perform the integrity verification for the SN by using an integrity algorithm that requires no additional verification information. For example, the reception side may perform the integrity verification for the data part in the packet, and, according to the verification result, indirectly determine whether the sequence number SN meets the integrity verification. If the data part does not pass the integrity verification, it is considered that the SN does not pass the integrity verification; otherwise, it is considered that the SN passes the integrity verification.

The integrity verification specifically includes: the reception side, which may be a terminal or a network side, uses an integrity protection verification algorithm to verify whether the received content (sequence number SN) is tampered. For example, according to the integrity protection algorithm together with other input information such as a key, if a calculation result of the algorithm does not match (or is the same as) part or all of the contents carried in the packet, the reception side considers that the SN of the packet is tampered; otherwise, the reception side may consider that the SN of the packet is not tampered.

If a verification result of the integrity verification in step 505 indicates that the SN passes the integrity verification, that is, the SN in the packet is not tampered, the reception side performs step 506; otherwise, the reception side discards the packet and/or notifies an upper-layer control part of an integrity verification failure.

506. If the terminal determines, according to the received SN, that the HFN needs to be updated, the packet reception side updates the hyper frame number HFN state on the packet reception side according to the sequence number SN.

If the radio link control layer uses an acknowledgement mode to transmit the packet to the reception side, the packet reception side uses the received SN as a basis to infer an HFN value used when the transmission side processes the packet; if determining that the difference obtained by subtracting the currently received SN from a next expected SN is greater than a reordering window, the reception side considers that the transmission side has begun to use the next HFN value, and updates the current HFN value of the reception side to HFN+1.

If the radio link control layer uses a non-acknowledgement mode to transmit the packet to the reception side, and if the received SN is less than the next expected SN, the reception side considers that the transmission side has begun to use the next HFN value, and updates the current HFN value of the reception side to HFN+1.

In the foregoing method, the anti-tampering protection process performed by the packet transmission side for the SN may be performed for the SN separately, or performed for the SN and other data in the packet together.

Corresponding to the method for updating a PDCP layer hyper frame number, this embodiment also provides an apparatus for updating a PDCP layer hyper frame number, which serves as a packet reception side, and provides an apparatus for sending a packet, which serves as a packet transmission side, where,

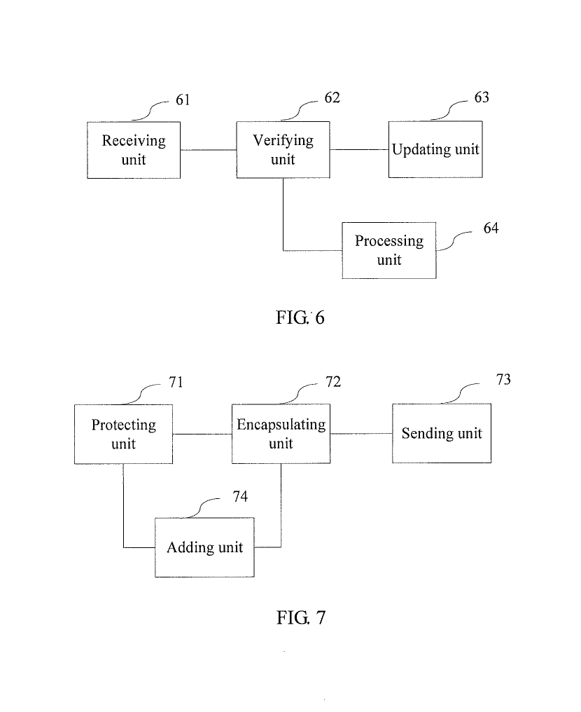

As shown in FIG. 6, the apparatus for updating a PDCP layer hyper frame number state includes:

a receiving unit 61, configured to receive a packet;

a verifying unit 62, configured to perform anti-tampering verification for a sequence number in the received packet; and

an updating unit 63, configured to update a hyper frame number state on the packet reception side according to the sequence number if a verification result generated by the verifying unit indicates that the sequence number passes the anti-tampering verification.

The apparatus for updating a PDCP layer hyper frame number state in this embodiment may further include:

a processing unit 64, configured to discard the packet or notify a control layer of a verification failure if a verification result generated by the verifying unit indicates that the sequence number does not pass the anti-tampering verification.

As shown in FIG. 7, the apparatus for sending a packet includes:

a protecting unit 71, configured to perform anti-tampering protection for a sequence number in a header of a packet to be sent;

an encapsulating unit 72, configured to encapsulate the packet; and

a sending unit 73, configured to send the encapsulated packet to a reception side.

Further, the apparatus for sending a packet in this embodiment may further include:

an adding unit 74, configured to add verification information required for anti-tampering verification into the packet, and then transfer the packet to the encapsulating unit.

In the method and apparatus for sending a packet, and the method and apparatus for updating a PDCP layer hyper frame number state according to the embodiment of the present invention, the sequence number SN undergoes anti-tampering protection on the packet transmission side; correspondingly, the packet reception side can perform anti-tampering verification for the SN in the received packet; the current hyper frame number HFN state on the reception side cannot be updated until the verification is passed, which solves the problems in the prior art such as a failure to decipher the packet subsequently because the hyper frame number HFN is incorrectly updated.

### Embodiment 3

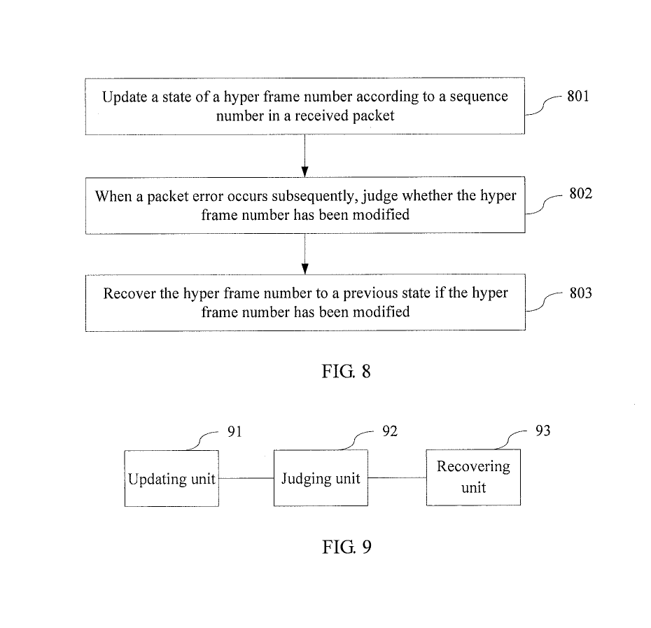

This embodiment of the present invention provides a method for maintaining a PDCP layer hyper frame number state. As shown in FIG. 8, the method includes the following steps:

801. Update a hyper frame number state according to a sequence number in a received packet.

802. When a packet error such as a packet deciphering failure occurs subsequently, determine whether the hyper frame number has been modified in the update process in step 801.

803. Recover the hyper frame number to a before-modification state if the hyper frame number has been modified.

The foregoing steps are performed by a reception side of the packet, which may be a terminal side or a network side.

Corresponding to the method for maintaining a PDCP layer hyper frame number state, this embodiment also provides an apparatus for maintaining a PDCP layer hyper frame number state. As shown in FIG. 9, the apparatus for maintaining a PDCP layer hyper frame number state includes:

an updating unit 91, configured to update a hyper frame number state according to a sequence number in a received packet;

a determining unit 92, configured to: when a packet error occurs subsequently, determine whether the hyper frame number has been modified; and

a recovering unit 93, configured to recover the hyper frame number to a before-modification state if a judgment result generated by the determining unit indicates that the hyper frame number has been modified.

In the method and apparatus for maintaining a PDCP layer hyper frame number state according to the embodiment of the present invention, if an error occurs when the reception side processes the received packet, the reception side determines whether the hyper frame number HFN has been modified, and recovers the hyper frame number state if the HFN has been modified, which solves the problems in the prior art such as a failure to decipher the packet subsequently because the hyper frame number is incorrectly updated. Compared with the prior art, the solutions in the embodiment of the present invention can solve the problem that the hyper frame number corresponding to a PDCP layer packet is updated incorrectly, and ensure that subsequent processes such as packet deciphering and/or integrity verification can be normally performed, which improves the success rate and reliability of data transmission and enhances quality of service of a system.

### Embodiment 4

In this embodiment, another specific instance is used to further describe a method for maintaining a hyper frame number state according to the embodiment of the present invention.

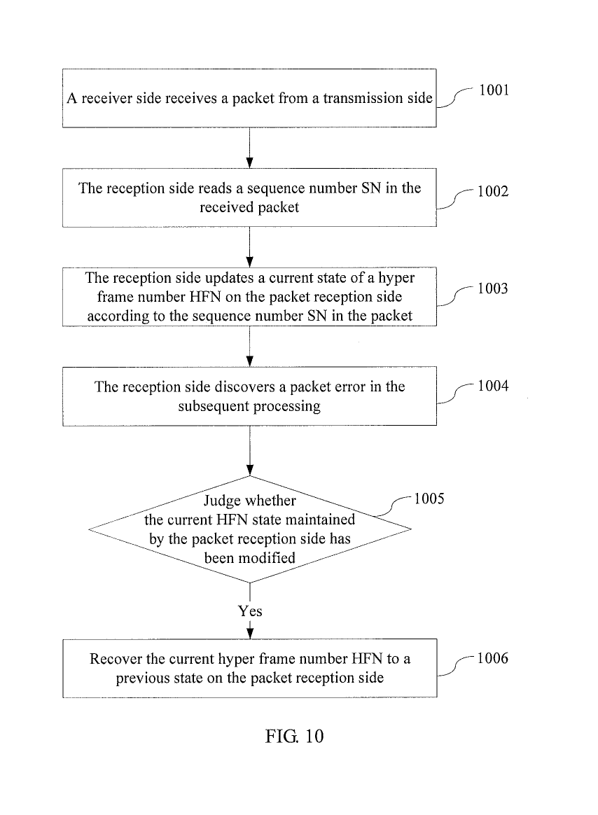

As shown in FIG. 10, the method for maintaining a hyper frame number state in this embodiment specifically includes the following steps:

1001. A reception side receives a packet from a transmission side.

The reception side and the transmission side may be a network side and a terminal respectively, or may be a terminal and a network side respectively.

1002. The reception side reads a sequence number SN in the received packet.

1003. The reception side updates a hyper frame number HFN state on the packet reception side according to the sequence number SN in the packet.

For example, if a radio link control layer uses an acknowledgement mode to transmit the packet to the reception side, and if a result of subtracting the currently received SN from a next expected SN is greater than a reordering window, the reception side updates the current HFN to HFN+1; if the reception side determines that no update is required, the HFN state is not updated in this step.

For another example, if the radio link control layer uses a non-acknowledgement mode to transmit the packet to the reception side, and if the received SN is less than the next expected SN, the reception side updates the current HFN to HFN+1; if the reception side determines that no update is required, the HFN state is not updated in this step.

1004. The reception side discovers a packet error. For example, a packet fails to be deciphered in the subsequent processing.

1005. Determine whether the hyper frame number HFN state maintained by the packet reception side has been modified in the update process in step 1003.

If the HFN state has been modified, perform step 1006; if the HFN state is not modified, perform no operation for the HFN state.

1006. Recover the hyper frame number HFN to a before-modification state on the packet reception side.

For example, when the HFN is updated to HFN+1 in step 1003, then the original HFN value needs to be recovered from HFN+1 when a packet error occurs.

Corresponding to the description of the foregoing method, this embodiment further provides a specific implementation instance.

In a scenario in which the radio link control layer uses an acknowledgement mode to transmit the packet to the reception side, as shown in FIG. 11, which shows the hyper frame number HFN state maintained by the reception side:

Last_Submitted_PDCP_RX_SN: an SN of a packet last submitted by the reception side to the upper layer, for example, 4000;

Next_PDCP_RX_SN: an SN of a next packet expected by the reception side, for example, 4001;

Received PDCP SN: a position of an SN of a packet currently received by the reception side, for example, 10;

Reordering Window: a reordering window, where all SNs may represent a half of a range. For example, all SNs in the FIG. 10 represent a range 0-4095, and therefore, the reordering window is 2048; and

HFN state on the reception side: The HFN may be any valid numerical value, for example, 80.

A process of modifying and recovering an HFN state:

In the case that the radio link control layer uses an acknowledgement mode to transmit the packet to the reception side, as shown in FIG. 11, the reception side receives the packet, and determines that Next_PDCP_RX_SN-received PDCP SN>Reordering_Window, and therefore, the reception side considers that the transmission side uses an HFN 81 when the packet is processed on the transmission side, which is different from the current HFN state 80 on the reception side. To be synchronized with the HFN on the transmission side, the reception side adds 1 to the HFN, that is, 80+1=81.

In the deciphering process, the reception side discovers that the packet is incorrectly deciphered. According to the present invention, the reception side needs to roll back the HFN update caused by the packet, and the reception side recovers the HFN to a before-modification state, that is, recovers HFN=80.

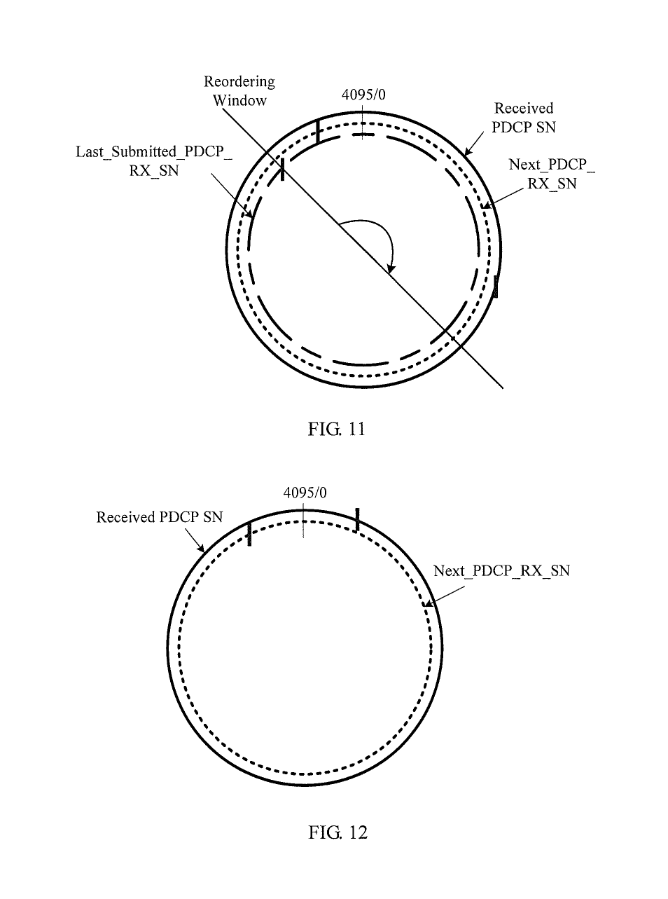

In a scenario where the radio link control layer uses a non-acknowledgement mode to transmit the packet to the reception side, with reference to the hyper frame number HFN state maintained by the reception side shown in FIG. 12, if the received SN (that is, Received PDCP SN) is less than the next expected SN (that is, Next_PDCP_RX_SN), the reception side updates the current HFN to HFN+1. In the deciphering process, the reception side discovers that the packet is incorrectly deciphered. According to the present invention, the reception side needs to roll back the HFN update caused by the packet, and the reception side recovers the HFN to a before-modification state.

In the method for maintaining a hyper frame number state according to the embodiment of the present invention, when the packet reception side discovers that the packet is erroneous or abnormal, the packet reception side determines whether the hyper frame number state on the packet reception side has been modified; considering that the packet error or exception is largely caused by incorrectly updating the hyper frame number, in the case that the packet is erroneous, the solution provided in this embodiment updates the hyper frame number state again, that is, recovers the hyper frame number to a before-modification state, so as to avoid the problems such as a failure to decipher the packet because the hyper frame number HFN is incorrectly updated in subsequent data processing.

In addition, in the embodiment of the present invention, the solutions provided in Embodiment 1 and Embodiment 2 may be combined with the solutions provided in Embodiment 3 and Embodiment 4. For example, after receiving a packet, the packet reception side may perform anti-tampering verification for the received packet first according to the solutions in Embodiment 1 and Embodiment 2, and update the hyper frame number state on the packet reception side if the anti-tampering verification is passed; then, according to the solutions in Embodiment 3 and Embodiment 4 if a packet error occurs, the reception side determines whether the hyper frame number has been modified, and recovers the hyper frame number to a before-modification state if the hyper frame number has been modified.

In the solutions described in all the foregoing embodiments, the hyper frame number HFN state on the packet reception side is updated/maintained. Nevertheless, the protection scope of the present invention is not limited to that. Like the HFN state, a PDCP context state may also be updated after undergoing anti-tampering verification, and then the PDCP context state may be recovered in the case that a packet error is discovered.

### Embodiment 5

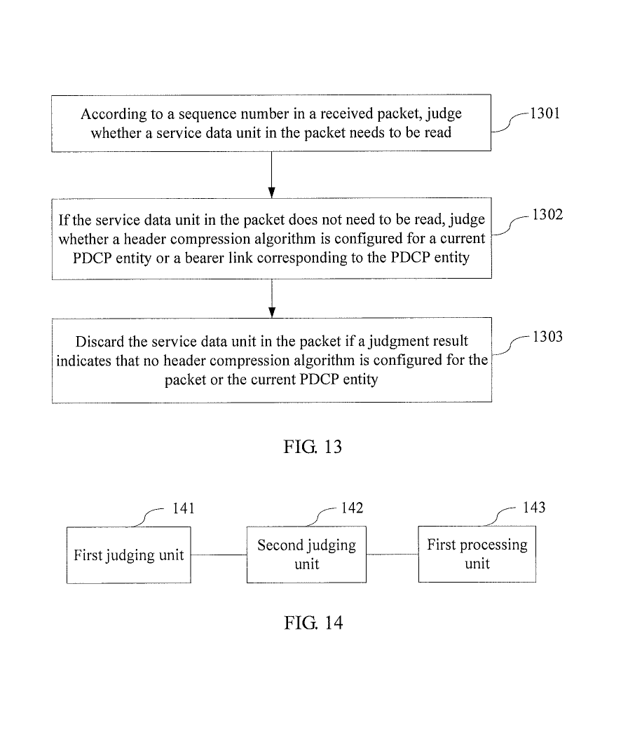

This embodiment of the present invention provides a method for processing PDCP layer data. As shown in FIG. 13, the method includes the following steps:

1301. According to a sequence number in a received packet, determine whether a service data unit in the packet needs to be read.

1302. If the service data unit in the packet does not need to be read, determine whether a header compression algorithm is configured for a current PDCP entity or a bearer link corresponding to the PDCP entity.

1303. Discard the service data unit in the packet if a result of the judgment indicates that no header compression algorithm is configured for the packet or the current PDCP entity.

The foregoing steps are performed by a reception side of the packet, which may be a terminal side or a network side.

Corresponding to the method, this embodiment further provides an apparatus for processing PDCP layer data. As shown in FIG. 14, the apparatus includes:

a first determining unit 141, configured to determine, according to a sequence number in a received packet, determine whether a service data unit in the packet needs to be read;

a second determining unit 142, configured to determine, if an output result of the first determining unit 141 indicates that the service data unit in the packet does not need to be read, determine whether a header compression algorithm is configured for a current PDCP entity or a bearer link corresponding to the PDCP entity; and

a first processing unit 143, configured to discard the service data unit in the packet if a judgment result generated by the second determining unit 142 indicates that no header compression algorithm is configured for the packet or the current PDCP entity.

In the method and apparatus for processing PDCP layer data according to the embodiment of the present invention, when the reception side of the packet does not need the service data unit carried in the packet, before deciphering the protocol data unit PDU in the received packet, the reception side determines whether the header compression algorithm is configured for the current PDCP entity or the bearer link corresponding to the PDCP entity, and, according to the judgment result, determines whether the PDU in the packet needs to be deciphered, so as to reduce unnecessary deciphering and decompression processing and reduce processing overhead on the reception side.

### Embodiment 6

The following uses a specific instance to describe the solution in Embodiment 5 in more detail.

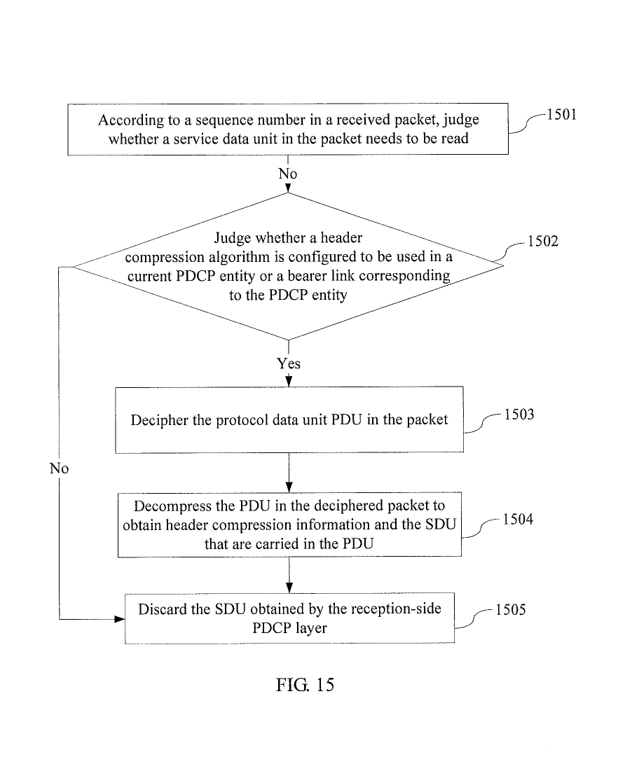

As shown in FIG. 15, the method for processing PDCP layer data in this embodiment includes the following steps:

1501. According to a sequence number SN in a received packet, determine whether a service data unit SDU in the packet needs to be read.

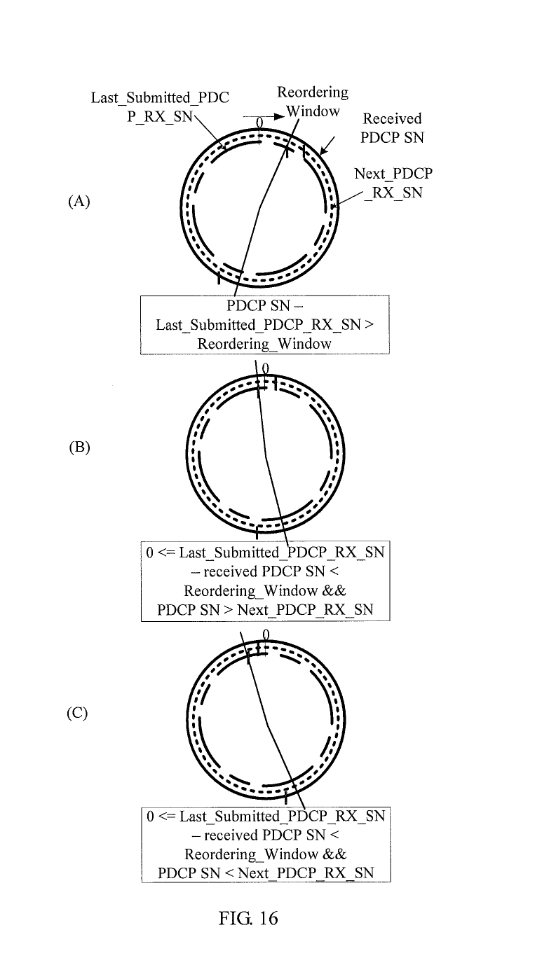

Specifically, the judgment process may base on the following judgment criteria (reference may be made to FIG. 16):

If the packet received by the reception side meets a condition that: a difference obtained by subtracting Last_Submitted_PDCP_RX_SN (an SN of a packet last submitted by the reception side to an upper layer) from Received PDCP SN (a position of an SN of a packet currently received by the reception side) is greater than a Reordering Window (reordering window) or a difference obtained by subtracting the Received PDCP SN from the Last_Submitted_PDCP_RX_SN is greater than or equal to 0 but less than the Reordering Window (see FIG. 16(A)), the PDCP SDU is discarded;

Further, if the received PDCP SN is greater than Next_PDCP_RX_SN (an SN of a next packet expected by the reception side) (see FIG. 16(B)), the PDCP PDU is deciphered, and a count value obtained based on the RX_HFN−1 and the received PDCP SN is applied; and

If the received PDCP SN is less than the Next_PDCP_RX_SN (see FIG. 16(C)), the PDCP PDU is deciphered, and a count value obtained based on the RX_HFN and the received PDCP SN is applied.

As seen from the foregoing description, if the SN carried in the protocol data unit PDU packet header in the packet received by the PDCP layer of the reception side meets the foregoing condition, it indicates that the PDCP layer of the reception side does not need the service data unit SDU carried in the packet.

1502. If the service data unit in the packet does not need to be read, determine whether a header compression algorithm is configured for a current PDCP entity or a bearer link corresponding to the PDCP entity.

In the case that a header compression algorithm is configured, a valid header compression algorithm is configured, or the header compression algorithm is not NULL.

If the judgment result in step 1502 is yes, perform steps 1503 to 1505; if the judgment result in step 1502 is no, perform step 1505.

1503. Decipher the protocol data unit PDU in the packet.

1504. Decompress the deciphered PDU in the packet to obtain header compression information and the SDU that are carried in the PDU.

1505. Discard the SDU obtained by the PDCP layer of the reception side.

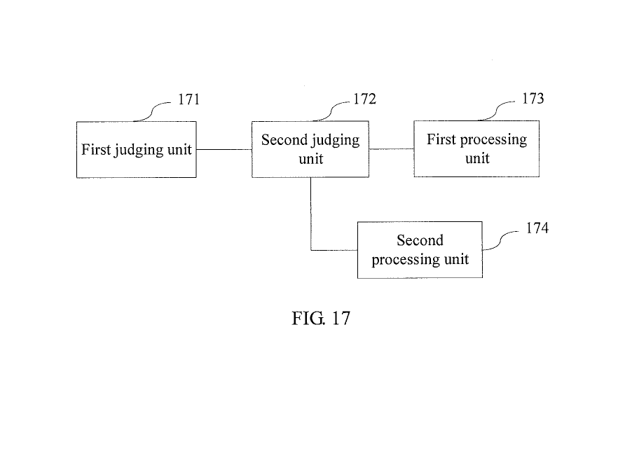

Corresponding to the foregoing method description, this embodiment further provides an apparatus for processing PDCP layer data. As shown in FIG. 17, the apparatus includes:

a first determining unit 171, configured to determine, according to a sequence number in a received packet, determine whether a service data unit in the packet needs to be read;

a second determining unit 172, configured to determine, if an output result of the first determining unit 171 indicates that the service data unit in the packet does not need to be read, determine whether a header compression algorithm is configured for a current PDCP entity or a bearer link corresponding to the PDCP entity; and

a first processing unit 173, configured to discard the service data unit in the packet if a judgment result generated by the second determining unit 172 indicates that no header compression algorithm is configured for the packet or the current PDCP entity.

The apparatus for processing PDCP layer data in this embodiment further includes:

a second processing unit 174, configured to decipher and decompress, if a judgment result generated by the second determining unit 172 indicates that a header compression algorithm is configured for the packet or the current PDCP entity, a protocol data unit in the packet to obtain header compression information, and discard the service data unit in the packet.

In the method and apparatus for processing PDCP layer data according to the embodiment of the present invention, when the reception side of the packet does not need the service data unit carried in the packet, before deciphering the protocol data unit PDU in the received packet, the reception side determines whether the header compression algorithm is configured for the current PDCP entity or the bearer link corresponding to the PDCP entity, and, according to the judgment result, determines whether the PDU in the packet needs to be deciphered, so as to reduce unnecessary deciphering and decompression processing and reduce processing overhead on the reception side.

The method and the apparatus in the embodiment of the present invention are applicable to communications systems such as LTE.

According to the description about the foregoing embodiments, a person skilled in the art can clearly understand that the present invention can be implemented by software in addition to a necessary hardware platform, or by hardware alone. Based on such understanding, all or a part of the technical solutions of the present invention contributing to the prior art may be implemented in a form of a software product. The computer software product is stored in a storage medium such as a Read Only Memory (ROM), a Random Access Memory (RAM), a magnetic disk, or an optical disc, and includes several instructions for instructing a computer device (which may be a personal computer, a server, a network device, and the like) to execute the method described in all or part of the embodiments of the present invention.

The foregoing descriptions are merely specific embodiments of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A method for processing data on Packet Data Convergence Protocol (PDCP) layer, comprising:
determining, by a reception side, based on a sequence number in a received packet, whether to read a service data unit in the received packet;
determining, by the reception side, whether a header compression algorithm is configured for a PDCP entity of the reception side or for a bearer link corresponding to the PDCP entity, when the service data unit in the received packet does not need to be read; and
discarding, by the reception side, the service data unit in the received packet, when no header compression algorithm is configured for the PDCP entity or for the bearer link corresponding to the PDCP entity.

2. The method according to claim 1, further comprising:
when the header compression algorithm is configured for the PDCP entity or for the bearer link corresponding to the PDCP entity, deciphering and decompressing, by the reception side, a protocol data unit in the received packet to obtain header compression information; and
discarding, by the reception, the service data unit in the received packet.

3. The method according to claim 1, the determining, based on the sequence number in the received packet, whether to read the service data unit in the received packet, comprises:
determining, by the reception side, that the service data unit in the received packet does not need to be read when the sequence number in the received packet meets a condition that:
a difference is greater than a reordering window, wherein the difference is obtained by subtracting a sequence number in a packet last delivered by the reception side to an upper layer from a sequence number in the received packet; or a difference is greater than or equal to 0 but less than the reordering window, wherein the difference is obtained by subtracting the sequence number in the received packet from the sequence number in the packet last delivered by the reception side to the upper layer.

4. An apparatus for processing data on Packet Data Convergence Protocol (PDCP) layer, comprising: a processor and a memory;
wherein the processor is configured to determine, based on a sequence number in a received packet, whether to read a service data unit in the received packet; and configured to determine, when the service data unit in the received packet does not need to be read, whether a header compression algorithm is configured for a PDCP entity of the apparatus or for a bearer link corresponding to the PDCP entity; and configured to discard the service data unit in the received packet when no header compression algorithm is configured for the PDCP entity or for the bearer link corresponding to the PDCP entity.

5. The apparatus according to claim 4, wherein the processor is further configured to decipher and decompress a protocol data unit in the received packet to obtain header compression information; and configured to discard the service data unit in the received packet, when a header compression algorithm is configured for the PDCP entity or for the bearer link corresponding to the PDCP entity.

6. The apparatus according to claim 4,
the processor configured to determine, based on the sequence number in the received packet, whether to read the service data unit in the receive packet, comprise:
the processor configured to determine whether the sequence number in the received packet meets a condition that:
a difference is greater than a reordering window, wherein the difference is obtained by subtracting a sequence number in a packet last delivered by the apparatus to an upper layer from a sequence number in the received packet; or
a difference is greater than or equal to 0 but less than the reordering window, wherein the difference is obtained by subtracting the sequence number in the received packet from the sequence number in the packet last delivered by the apparatus to the upper layer;

7. The apparatus according to claim 6,
when the condition is met, the processor is further configured to generate that the service data unit in the received packet does not need to be read.

8. An apparatus for maintaining a Packet Data Convergence Protocol (PDCP) layer hyper frame number state, comprising: a processor and a memory;
wherein the processor is configured to update a hyper frame number state based on a sequence number in a received packet; and configured to determine, when a packet error occurs subsequently, determine whether the hyper frame number has been modified; and
configured to recover the hyper frame number to a before-modification state when the hyper frame number has been modified.

9. The apparatus according to claim 7, wherein the packet error comprises a packet deciphering failure.

10. The apparatus according to claim 7, wherein
before the processor updates the hyper frame number state, the processor is further configured to perform anti-tampering verification for the sequence number in the received packet and to determine the processor updates the hyper frame number state when the anti-tampering verification passes.
